(19) United States
(12) Patent Application Publication
(10) Pub. No.: US 2026/0275544 A1
(43) Pub. Date: Sep. 17, 2026

(54) ALKALINE ELECTROLYZER STRUCTURE

(71) Applicant: L'Air Liquide, Société Anonyme pour I'Etude et I'Exploitation des Procédés Georges Claude, Paris (FR)

(72) Inventors: Denis SIRAC, Grenoble (FR); Florent BEILLE, Lans-en-Vercors (FR)

(21) Appl. No.: 19/556,844

(22) Filed: Mar. 4, 2026

(30) Foreign Application Priority Data
Mar. 17, 2025 (FR) FR2502655

(51) Int. Cl. C25B 11/036; C25B 9/75; C25B 13/02

(52) U.S. Cl. CPC C25B 11/036; C25B 9/75; C25B 13/02

(57) ABSTRACT

The disclosure describes an alkaline electrolyzer structure with:
a bipolar plate containing four through-holes, so as to allow a first electrolyte and a second electrolyte to flow through the bipolar plate;
four electrically insulating rings each containing a central void and each being intended to be inserted into each respective through-hole in the thickness of the bipolar plate, so as to reduce the cross-sectional area of the through-hole and so as to form an electrical insulation between one of the electrolytes and the bipolar plate, when one of the electrolytes passes through the central void of the ring.

### CROSS REFERENCE TO RELATED APPLICATIONS

This application claims the benefit of priority under 35 U.S.C. § 119 (a) and (b) to French Patent Application No. FR2502655, filed Mar. 17, 2025, the entire contents of which are incorporated herein by reference.

### BACKGROUND

The present invention relates to an alkaline electrolyzer structure and to an alkaline electrolyzer such as an AEM electrolyzer.

An electrolyzer for water electrolysis is an electrochemical reactor configured to subject water to an electromotive force so as to generate dioxygen and dihydrogen through electrolysis of water.

This type of electrolyzer generally comprises a stack of cells each comprising two frames sandwiching a membrane, each frame allowing the diffusion of an electrolyte through a porous material.

The electrolysis reaction occurring in the cells generates heat which, for optimal operation of the electrolyzer, has to be removed. Generally, the electrolyte, the water of which is intended to be electrolyzed, is also used as a vector for removing the heat generated by the electrolysis reaction from the stack.

The cells each define an oxygen compartment (or anode compartment) between an anode plate and the membrane, for collecting dioxygen, and a hydrogen compartment (or cathode compartment) between a cathode plate and the membrane, for collecting dihydrogen.

The anode plate and cathode plate may be connected to each other to form a bipolar plate.

The cells of an electrolyzer are intended both to be placed under a voltage and to be fluidly connected with the conductive electrolyte. Thus, ionic currents exist and may pass through the electrolyte rather than through the membranes.

These currents, which are called shunt currents, reduce the efficiency of the cells. They may also cause unwanted parasitic reactions.

### SUMMARY

The present invention aims to effectively remedy these drawbacks by providing an alkaline electrolyzer structure, the structure being intended to be stacked in an alkaline electrolyzer such as an AEM electrolyzer, the structure comprising:
a bipolar plate containing four through-holes, so as to allow a first electrolyte and a second electrolyte to flow through the bipolar plate;
four electrically insulating rings each containing a central void and each being intended to be inserted into each respective through-hole in the thickness of the bipolar plate, so as to reduce the cross-sectional area of the through-hole and so as to form an electrical insulation between one of the electrolytes and the bipolar plate, when one of the electrolytes passes through the central void of the ring;
a first frame;
a second frame;
   each frame being equipped with a distribution face for distributing the first electrolyte and second electrolyte, respectively, and with a bearing face, each frame comprising:
an inlet manifold orifice that passes through the frame with a view to supplying the first electrolyte and second electrolyte to the respective distribution faces;
an outlet manifold orifice that passes through the frame with a view to removing the first electrolyte and second electrolyte from the respective distribution faces;
a first aperture that passes through the frame with a view to letting the second electrolyte and first electrolyte pass in a respective direction of a thickness of the frame;
a second aperture that passes through the frame with a view to letting the second electrolyte and first electrolyte pass in the respective direction of the thickness of the frame,
   the structure being intended to be assembled in such a way that the bipolar plate is sandwiched between the first frame and the second frame, each ring being interposed between the first frame and the second frame by being inserted into each respective through-hole in the thickness of the bipolar plate.

This makes it possible to significantly limit the shunt currents in an electrolyzer comprising a stack of such structures, in particular by increasing the electrical insulation between the electrolyzer cells.

According to one embodiment, each ring has a thickness at least equal to the thickness of the first frame or second frame.

According to one embodiment, each ring has a thickness at least equal to 0.2 mm.

According to one embodiment, the thickness of the ring is considered to include an optional seal making contact with either or both of its faces.

According to one embodiment, each ring has a thickness at least equal to the thickness of the bipolar plate.

According to one embodiment, each ring has a thickness less than or equal to the thickness of the bipolar plate.

According to one embodiment, each ring has a width of at least 1 mm.

According to one embodiment, each frame comprises a central housing for receiving a porous material, in particular so that each frame may allow diffusion of the first electrolyte or second electrolyte through the porous material.

According to one embodiment, the bipolar plate comprises an anode plate and a cathode plate.

According to one embodiment, the cathode plate is fastened to the anode plate.

According to one embodiment, the cathode plate and the anode plate belong to the same bipolar plate and are in particular made of the same material as and integrally formed with the bipolar plate.

According to one embodiment, the structure comprises a first insulating film such as a PTFE film, which is interposed between the distribution face of the first frame and the bipolar plate, and which in particular is intended to be clamped so as to form a fluidic insulation and/or a seal with respect to the first electrolyte or second electrolyte, the structure comprising a second insulating film such as a PTFE film, which is interposed between the distribution face of the second frame and the bipolar plate, and which in particular is intended to be clamped so as to form a seal and/or an electrical insulation with respect to the second electrolyte or first electrolyte.

According to one embodiment, each ring has a thickness at least equal to the thickness of the first insulating film or a thickness at least equal to the thickness of the second insulating film.

According to one embodiment, the structure is intended to be assembled in such a way that the inlet manifold orifice of the first frame faces the first aperture of the second frame and faces a central void of one of the rings, so as to define an inlet manifold for the first electrolyte.

According to one embodiment, the structure is intended to be assembled in such a way that the outlet manifold orifice of the first frame faces the second aperture of the second frame and faces a central void of one of the rings, so as to define an outlet manifold for the first electrolyte.

According to one embodiment, the structure is intended to be assembled in such a way that the inlet manifold orifice of the second frame faces the first aperture of the first frame and faces a central void of one of the rings, so as to define an inlet manifold for the second electrolyte.

According to one embodiment, the structure is intended to be assembled in such a way that the outlet manifold orifice of the second frame faces the second aperture of the first frame and faces a central void of one of the rings, so as to define an outlet manifold for the second electrolyte.

According to one embodiment, at least one of the rings is integral with the first frame or second frame, and is in particular made of the same material as and integrally formed with the first frame or second frame, only one of the first insulating film and second insulating film in particular being intended to be clamped between said ring and said frame.

According to one embodiment, at least one of the rings is free with respect to the first frame or second frame, while in particular being intended to be clamped between the first frame and second frame with interposition of a portion of the first insulating film between the first frame and said ring and with interposition of a portion of the second insulating film between the second frame and said ring.

According to one embodiment, at least one of the rings and/or the distribution face of the first frame and/or the distribution face of the second frame comprises reliefs and recesses, forming a clamping zone with respect to the first insulating film or second insulating film.

According to one embodiment, the thickness of each ring is considered to include the clamping zone.

The invention further relates to an alkaline electrolyzer, such as an AEM electrolyzer, comprising a stack of a plurality of structures such as described above.

According to one embodiment, the electrolyzer comprises at least one membrane sandwiched between two structures.

According to one embodiment, the membrane is an anionic exchange membrane or a cationic exchange membrane or a porous membrane of diaphragm type.

According to one embodiment, the membrane is sandwiched between two frames, in particular between one of the frames of one of the two structures and one of the frames of another of the two structures.

According to one embodiment, the stack of the plurality of structures defines a plurality of electrolyzer cells, a cell in particular comprising the membrane and the two frames adjacent to it.

According to one embodiment, the electrolyzer is intended to electrolyze water.

According to one embodiment, the electrolyzer is a PEM electrolyzer (PEM standing for Proton Exchange Membrane) or an alkaline electrolyzer such as an AEM electrolyzer (AEM standing for Anion Exchange Membrane) or an AEL electrolyzer (AEL standing for Alkaline ELectrolysis).

According to one embodiment, the electrolyzer comprises a first collector plate at a first end of the stack and a second collector plate at a second end of the stack, with a view to collecting an electrical current.

The invention may also relate to any alternative device or method comprising any combination of the features above or below.

### BRIEF DESCRIPTION OF THE DRAWINGS

The invention will be understood better on reading the following description and on studying the accompanying figures. These figures are given merely by way of illustration and do not in any way limit the invention.

FIG. 1 is a schematic exploded view of a structure according to the invention; and

FIG. 2 is a schematic cross-sectional view of a stack of two structures shown in FIG. 1 and of two membranes.

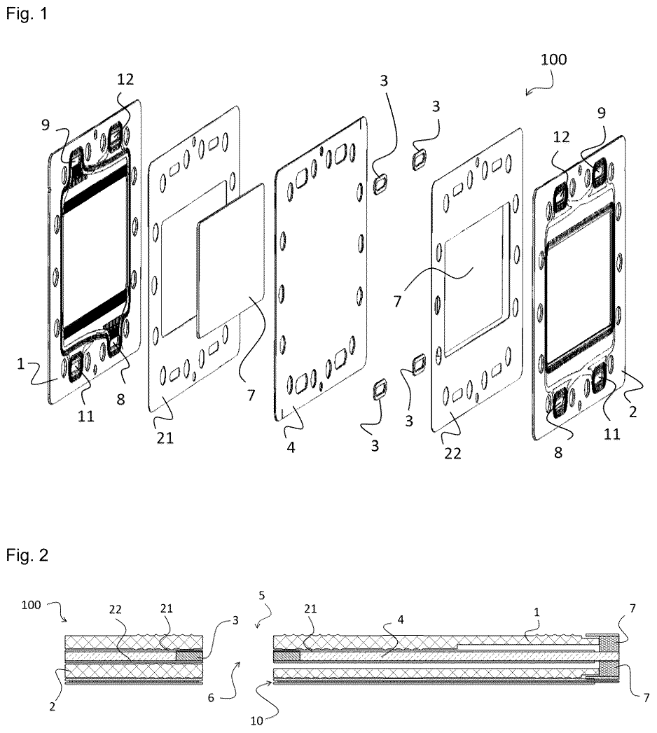

FIG. 1 shows an alkaline electrolyzer structure 100.

### DETAILED DESCRIPTION OF THE PREFERRED EMBODIMENTS

The alkaline electrolyzer structure 100 of FIG. 1 is intended to be stacked in an alkaline electrolyzer such as an AEM electrolyzer. The structure 100 comprises:
a bipolar plate 4 containing four through-holes 5, so as to allow a first electrolyte and a second electrolyte to flow through the bipolar plate 4;
four electrically insulating rings 3 each containing a central void 6 and each being intended to be inserted into each respective through-hole 5 in the thickness of the bipolar plate 4, so as to reduce the cross-sectional area of the through-hole 5 and so as to form an electrical insulation between one of the electrolytes and the bipolar plate 4, when one of the electrolytes passes through the central void 6 of the ring 3;
a first frame 1;
a second frame 2.

Each frame 1, 2 is equipped with a distribution face for distributing the first electrolyte and second electrolyte, respectively, and with a bearing face. Each frame 1, 2 comprises:
an inlet manifold orifice 8 that passes through the frame 1, 2 with a view to supplying the first electrolyte and second electrolyte to the respective distribution faces;
an outlet manifold orifice 9 that passes through the frame 1, 2 with a view to removing the first electrolyte and second electrolyte from the respective distribution faces;
a first aperture 11 that passes through the frame 1, 2 with a view to letting the second electrolyte and first electrolyte pass in a respective direction of a thickness of the frame 1, 2;
a second aperture 12 that passes through the frame 1, 2 with a view to letting the second electrolyte and first electrolyte pass in the respective direction of the thickness of the frame 1, 2.

The structure 100 is intended to be assembled in such a way that the bipolar plate 4 is sandwiched between the first frame 1 and the second frame 2, each ring being interposed between the first frame 1 and the second frame 2 by being inserted into each respective through-hole 5 in the thickness of the bipolar plate 4.

The structure 100 comprises a first insulating film 21 such as a PTFE film, interposed between the distribution face of the first frame 1 and the bipolar plate 4, and in particular being intended to be clamped so as to form a fluidic insulation and/or a seal with respect to the first electrolyte or second electrolyte.

The structure 100 comprises a second insulating film 22 such as a PTFE film, interposed between the distribution face of the second frame 2 and the bipolar plate 4, and in particular being intended to be clamped so as to form a seal and/or an electrical insulation with respect to the second electrolyte or first electrolyte.

The structure 100 is intended to be assembled in such a way that the inlet manifold orifice 8 of the first frame 1 faces the first aperture 11 of the second frame 2 and faces a central void 6 of one of the rings 3, so as to define an inlet manifold for the first electrolyte.

The structure 100 is intended to be assembled in such a way that the outlet manifold orifice 9 of the first frame 1 faces the second aperture 12 of the second frame 2 and faces a central void 6 of one of the rings 3, so as to define an outlet manifold for the first electrolyte.

The structure 100 is intended to be assembled in such a way that the inlet manifold orifice 8 of the second frame 2 faces the first aperture 11 of the first frame 1 and faces a central void 6 of one of the rings 3, so as to define an inlet manifold for the second electrolyte.

The structure 100 is intended to be assembled in such a way that the outlet manifold orifice 9 of the second frame 2 faces the second aperture 12 of the first frame 1 and faces a central void 6 of one of the rings 3, so as to define an outlet manifold for the second electrolyte.

At least one of the rings 3 is integral with the first frame 1 or second frame 2, and is in particular made of the same material as and integrally formed with the first frame 1 or second frame 2, only one of the first insulating film 21 and second insulating film 22 in particular being intended to be clamped between said ring 3 and said frame 1, 2.

Each frame 1, 2 comprises a central housing for receiving a porous material 7, in particular so that each frame may allow diffusion of the first electrolyte or second electrolyte through the porous material 7.

FIG. 2 is a schematic cross-sectional view of a stack of two structures 100 with a membrane 10 interposed between each structure 100. The membrane 10 is sandwiched between two structures. In the stack shown in FIG. 2, the membrane 10 is sandwiched between two frames 1, 2, and in particular between one of the frames 1, 2 of one of the two structures 100 and one of the frames 1, 2 of another of the two structures 100.

A cell 50 of an electrolyzer may be defined as being formed by a stack of a frame of a structure 1, 2, of a membrane 50 and of a frame 1, 2 of another adjacent structure 100.

Thus, an electrolyzer is formed by a stack of a plurality of cells 50 and of a plurality of bipolar plates 4, each bipolar plate 4 being sandwiched between two cells 50.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. An alkaline electrolyzer structure (100), the structure being intended to be stacked in an alkaline electrolyzer, the structure (100) comprising:
a bipolar plate (4) containing four through-holes (5), configured so as to allow a first electrolyte and a second electrolyte to flow through the bipolar plate (4);
four electrically insulating rings (3) each containing a central void (6) and each being intended to be inserted into each respective through-hole (5) in the thickness of the bipolar plate (4), so as to reduce the cross-sectional area of the through-hole (5) and so as to form an electrical insulation between the first and second electrolytes and the bipolar plate (4), when the first and second electrolytes passes through the central void (6) of the ring (3);
a first frame (1);
a second frame (2);
each frame (1, 2) being equipped with a distribution face for distributing the first electrolyte and second electrolyte, respectively, and with a bearing face, each frame (1, 2) comprising:
an inlet manifold orifice (8) that passes through the frame (1, 2) which is configured to supply the first electrolyte and second electrolyte to the respective distribution faces;
an outlet manifold orifice (9) that passes through the frame (1, 2) which is configured to remove the first electrolyte and second electrolyte from the respective distribution faces;
a first aperture (11) that passes through the first and second frames (1, 2) which is configured to allow the second electrolyte and first electrolyte to pass in a respective direction of a thickness of the frame (1, 2);
a second aperture (12) that passes through the first and second frames (1, 2) which is configured to allow the second electrolyte and first electrolyte pass in the respective direction of the thickness of the frame (1, 2),
the structure (100) being configured and adapted to be assembled in such a way that the bipolar plate (4) is sandwiched between the first frame (1) and the second frame (2), each ring being interposed between the first frame (1) and the second frame (2) by being inserted into each respective through-hole (5) in the thickness of the bipolar plate (4).

2. The structure (100) according to claim 1, further comprising a first insulating film (21), which is interposed between the distribution face of the first frame (1) and the bipolar plate (4), and which is configured to be capable of being clamped so as to form a fluidic insulation and/or a seal with respect to the first electrolyte or second electrolyte, the structure comprising a second insulating film (22), which is interposed between the distribution face of the second frame (2) and the bipolar plate (4), and which configured to be capable of to being clamped so as to form a seal and/or an electrical insulation with respect to the second electrolyte or first electrolyte.

3. The structure (100) according to claim 1, configured to be capable of being assembled in such a way that the inlet manifold orifice (8) of the first frame (1) faces the first aperture (11) of the second frame (2) and faces a central void (6) of one of the rings (3), so as to define an inlet manifold for the first electrolyte.

4. The structure (100) according to claim 1, configured to be capable of being assembled in such a way that the outlet manifold orifice (9) of the first frame (1) faces the second aperture (12) of the second frame (2) and faces a central void (6) of one of the rings (3), so as to define an outlet manifold for the first electrolyte.

5. The structure (100) according to claim 1, configured to be capable of being assembled in such a way that the inlet manifold orifice (8) of the second frame (2) faces the first aperture (11) of the first frame (1) and faces a central void (6) of one of the rings (3), so as to define an inlet manifold for the second electrolyte.

6. The structure (100) according to claim 1, configured to be capable of being assembled in such a way that the outlet manifold orifice (9) of the second frame (2) faces the second aperture (12) of the first frame (1) and faces a central void (6) of one of the rings (3), so as to define an outlet manifold for the second electrolyte.

7. The structure (100) according to claim 2, wherein at least one of the rings (3) is integral with the first frame (1) or second frame (2), and made of the same material as and integrally formed with the first frame (1) or second frame (2).

8. The structure (100) according to claim 2, wherein at least one of the rings (3) is not integral or attached with respect to the first frame (1) or second frame (2), and is adapted to be clamped between the first frame (1) and second frame (2) with an interposition of a portion of the first insulating film (21) between the first frame (1) and said ring (3) and with an interposition of a portion of the second insulating film (22) between the second frame (2) and said ring (3).

9. The structure (100) according to claim 2, wherein at least one of the rings (3) and/or the distribution face of the first frame (1) and/or the distribution face of the second frame (2) comprises reliefs and recesses, forming a clamping zone with respect to the first insulating film (21) or second insulating film (22).

10. An alkaline electrolyzer, comprising a stack of a plurality of structures (100) according to claim 1.
